(19) United States
(12) Patent Application Publication
(10) Pub. No.: US 2025/0348249 A1
(43) Pub. Date: Nov. 13, 2025

(54) SERVICE PROVIDING SYSTEM, SERVICE PROVIDING SERVER, PRINT SETTING ASSISTANCE METHOD AND NON-TRANSITORY COMPUTER-READABLE RECORDING MEDIUM ENCODED WITH PRINT SETTING ASSISTANCE PROGRAM

(71) Applicant: Konica Minolta, Inc., Tokyo (JP)

(72) Inventors: Kei YUASA, Sagamihara-shi (JP); Takashi AKAZAWA, Tokyo (JP); Ryoei IKARI, Tokorozawa-shi (JP); Toshihiro WAZUMI, Tokyo (JP)

(21) Appl. No.: 19/201,066

(22) Filed: May 7, 2025

(30) Foreign Application Priority Data
May 9, 2024 (JP) 2024-076334

(51) Int. Cl. G06F 3/12

(52) U.S. Cl. CPC G06F 3/1205; G06F 3/1254; G06F 3/1273; G06F 3/1288

(57) ABSTRACT

A service providing system includes a hardware processor, wherein the hardware processor acquires respective state information and job information as respective first state information and first job information, with the state information relating to a first image forming apparatus, and with the job information relating to a first print job to be executed by the first image forming apparatus, and outputs setting information for execution of the first print job by using a learning model, with the setting information being determined based on the first state information and the first job information, and with the learning model having executed machine learning using second state information that is the state information of each of a plurality of second image forming apparatuses and second job information corresponding to a second print job that has been executed in each of the plurality of second image forming apparatuses.

### CROSS-REFERENCE TO RELATED APPLICATIONS

The entire disclosure of Japanese patent Application No. 2024-076334 filed on May 9, 2024, is incorporated herein by reference in its entirety.

### BACKGROUND OF THE INVENTION

### Technical Field

The present invention relates to a service providing system, a service providing server, a print setting assistance method, and a non-transitory computer-readable recording medium encoded with a print setting assistance program. In particular, the present invention relates to a service providing system that assists setting for execution of a print job by an image forming apparatus, a service providing server, a print setting assistance method executed by the service providing server, and a non-transitory computer-readable recording medium encoded with a print setting assistance program that causes a computer to execute the print setting assistance method.

### Description of Related Art

In a case in which an image forming apparatus executes a print job, it is necessary to set values for various setting items. In the setting work, since there are a plurality of setting items, a user is required to be skilled for printing with high image quality. In particular, in a case in which an image forming apparatus is used to produce a printed material ordered by a client, more detailed settings may be required.

For example, Japanese Unexamined Patent Publication No. 2015-150792 describes a print setting control device that has a display that performs an analysis on a print job and displays a temporary print setting based on a result of the analysis, an acceptor that accepts change contents for the temporary print setting, and an updater that updates statistic information based on the change contents, wherein the display is characterized by displaying the temporary print setting based on the statistic information.

On the other hand, setting contents may be different depending on a difference in state of an image forming apparatus. For example, image quality that is obtained using a photosensitive drum nearing the end of the service life is different from the image quality that is obtained using the photosensitive drum that has recently been replaced. Therefore, with the print setting control device described in Japanese Unexamined Patent Publication No. 2015-150792, there is a problem that most suitable print settings are not always displayed for different states of the image forming apparatus.

### SUMMARY OF THE INVENTION

In order to achieve the above-mentioned object, according to one aspect of the present invention, a service providing system includes a hardware processor, wherein the hardware processor acquires respective state information and job information as respective first state information and first job information, with the state information representing a characteristic of a device use state relating to a first image forming apparatus, and with the job information representing a characteristic of a print job relating to a first print job to be executed by the first image forming apparatus, and outputs setting information for execution of the first print job by using a learning model, with the setting information being determined based on the first state information and the first job information, and with the learning model having executed machine learning using second state information that is the state information of each of a plurality of second image forming apparatuses and second job information that is the job information corresponding to a second print job that has been executed in each of the plurality of second image forming apparatuses.

According to another aspect of the present invention, a service providing server includes a data acquirer that acquires respective state information and job information as respective first state information and first job information, with the state information representing a characteristic of a device use state relating to a first image forming apparatus, and with the job information representing a characteristic of a print job relating to a first print job to be executed by the first image forming apparatus, and a setting outputter that outputs setting information for execution of the first print job by using a learning model, with the setting information being determined based on the first state information and the first job information, and with the learning model having executed machine learning using second state information that is the state information of each of a plurality of second image forming apparatuses and second job information that is the job information corresponding to a second print job that has been executed in each of the plurality of second image forming apparatuses.

According to yet another aspect of the present invention, a print setting assistance method causes a service providing server to execute a data acquiring step of acquiring respective state information and job information as respective first state information and first job information, with the state information representing a characteristic of a device use state relating to a first image forming apparatus, and with the job information representing a characteristic of a print job relating to a first print job to be executed by the first image forming apparatus, and a setting output step of outputting setting information for execution of the first print job by using a learning model, with the setting information being determined based on the first state information and the first job information, and with the learning model having executed machine learning using second state information that is the state information of each of a plurality of second image forming apparatuses and second job information that is the job information corresponding to a second print job that has been executed in each of the plurality of second image forming apparatuses.

According to yet another aspect of the present invention, a non-transitory computer-readable recording medium encoded with a print setting assistance program that causes a computer to execute a data acquiring step of acquiring respective state information and job information as respective first state information and first job information, with the state information representing a characteristic of a device use state relating to a first image forming apparatus, and with the job information representing a characteristic of a print job relating to a first print job to be executed by the first image forming apparatus, and a setting output step of outputting setting information for execution of the first print job by using a learning model, with the setting information being determined based on the first state information and the first job information, and with the learning model having executed machine learning using second state information that is the state information of each of a plurality of second image forming apparatuses and second job information that is the job information corresponding to a second print job that has been executed in each of the plurality of second image forming apparatuses.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 is a diagram illustrating one example of the overview of a service providing system in a first embodiment of the present invention;

FIG. 2 is a block diagram illustrating one example of the outline of the hardware configuration of a server in the present embodiment;

FIG. 3 is a cross-sectional view schematically illustrating one example of the inner configuration of an MFP;

FIG. 4 is a block diagram illustrating the outline of the hardware configuration of the MFP in the present embodiment;

FIG. 5 is a block diagram illustrating one example of the functions of a CPU included in a server in the present embodiment;

FIG. 6 is a diagram illustrating one example of the format of state information;

FIG. 7 is a diagram illustrating one example of the format of job information;

FIG. 8 is a diagram illustrating one example of related information;

FIG. 9 is a flowchart illustrating one example of a flow of a model generation process;

FIG. 10 is a flowchart illustrating one example of a flow of a print setting assistance process;

FIG. 11 is a block diagram illustrating one example of the functions of a CPU included in a server 200 in a modified example;

FIG. 12 is a flowchart illustrating one example of a flow of a history information generation process;

FIG. 13 is a block diagram illustrating one example of the functions of a CPU included in a server in a second embodiment;

FIG. 14 is a flowchart illustrating one example of a flow of a model generation process in the second embodiment; and

FIG. 15 is a flowchart illustrating one example of a flow of a print setting assistance process in the second embodiment.

### DETAILED DESCRIPTION

Hereinafter, one or more embodiments of the present invention will be described with reference to the drawings. However, the scope of the invention is not limited to the disclosed embodiments.

Embodiments of the present invention will be described below with reference to the drawings. In the following description, the same components are denoted by the same reference numerals. Their names and functions are the same. Therefore, a detailed description thereof will not be repeated.

### First Embodiment

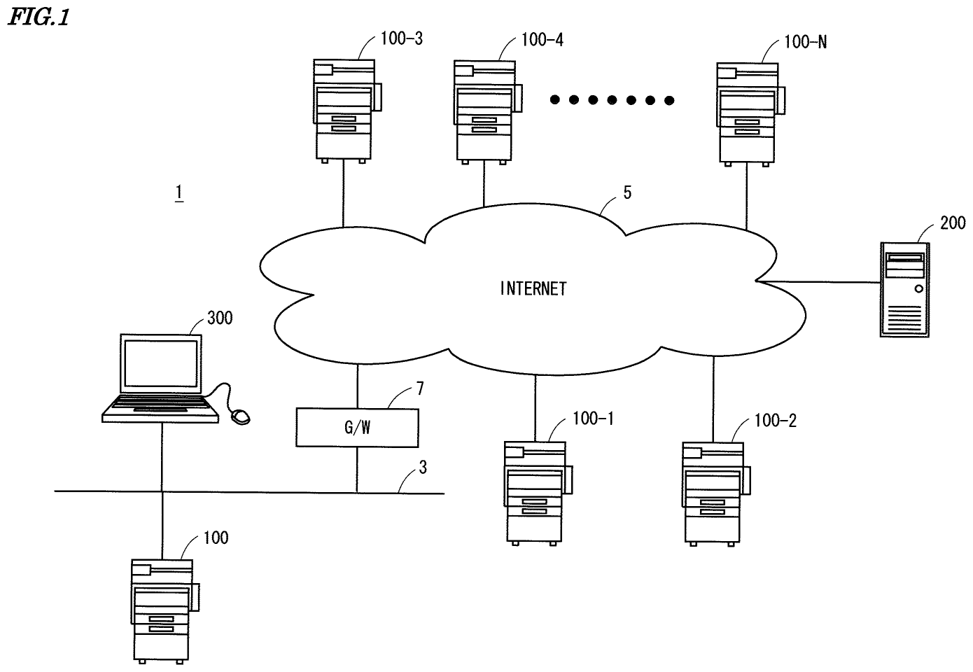

FIG. 1 is a diagram illustrating one example of the overview of a service providing system in a first embodiment of the present invention. With reference to FIG. 1, the service providing system 1 includes a server 200, a plurality of multifunction peripherals (MFPs) 100, 100-1 to 100-N (N is a positive integer), and a personal computer (hereinafter referred to as a “PC”) 300.

The MFP 100 is one example of a first image forming apparatus. The MFPs 100-1 to 100-N are examples of a second image forming apparatus. While commonly having the functions of an image forming apparatus, the MFPs 100, 100-1 to 100-N may have the same installed hardware and the same installed programs, or may have different installed hardware and different installed programs. The programs to be installed on each of the MFPs 100, 100-1 to 100-D include a program for processing image data and other application programs in addition to a program for controlling the hardware included therein.

The PC 300 is a general computer. The PC 300 and the MFP 100 are connected to a network 3. The network 3 is a local area network (LAN). The PC 300 and the MFP 100 can communicate with each other through the network 3. A driver program for controlling the MFP 100 is installed in the PC 300. Therefore, a user who operates the PC 300 can cause the MFP 100 to execute a print job. When the user inputs image data and setting information such as a print condition to the PC 300, the PC 300 generates a print job, and the MFP 100 executes the print job.

The network 3 is connected to the Internet 5 through a gateway (G/W) 7. The server 200 and the plurality of MFPs 100-1 to 100-N are connected to the Internet 5.

The server 200 is a general computer. The server 200 can communicate with the MFPs 100-1 to 100-N through the Internet 5, and can communicate with the PC 300 and the MFP 100 through the Internet 5 and the network 3. The network 3 is not limited to a LAN, and may be a Wide Area Network (WAN) or the Internet.

In the service providing system 1 in the present embodiment, the server 200 assists a user operation of causing any one of the MFPs 100, 100-1 to 100-N to execute a print job. Here, the user operates the PC 300 and causes the MFP 100 to execute a print job, by way of example.

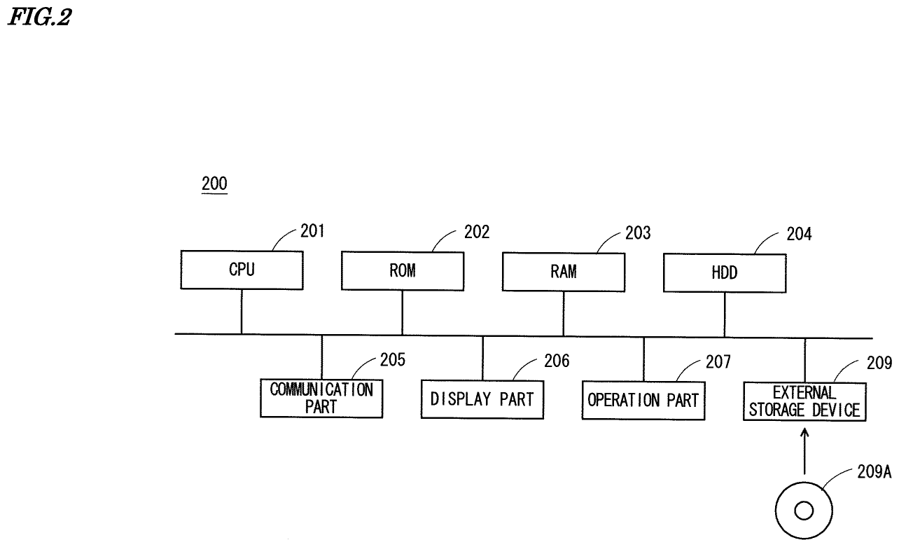

FIG. 2 is a block diagram illustrating one example of the outline of the hardware configuration of the server in the present embodiment. With reference to FIG. 2, the server 200 includes a CPU 201 for controlling the server 200 as a whole, a ROM 202, a RAM 203, a hard disc drive (HDD) 204, a communication part 205, a display part 206, an operation part 207 and an external storage device 209.

The ROM 202 stores a program to be executed by the CPU 201. The RAM 203 is used as a work area for the CPU 201. The HDD 204 is a mass storage device that stores data in a non-volatile manner. Instead of the HDD 204, a solid state drive (SSD) may be used. The communication part 205 connects the CPU 201 to the network 3. The operation part 207 accepts an operation input by the user. Although not being limited, the display part 206 is a liquid crystal display device. An organic electroluminescence (EL) display may be used instead of a liquid crystal display device.

The external storage device 209 is mounted with a Compact Disk Read Only Memory (CD-ROM) 209A. In the present embodiment, the CPU 201 executes a program stored in the ROM 202, by way of example. However, the CPU 201 may control the external storage device 209 to read a program to be executed by the CPU 201 from the CD-ROM 209A, store the read program in the RAM 203 and execute the program.

A recording medium for storing a program to be executed by the CPU 201 is not limited to the CD-ROM 209A but may be a medium such as a flexible disc, a cassette tape, an optical disc or a semiconductor memory. The optical disc includes Magnetic Optical Disc (MO)/MiniDisc (MD)/Digital Versatile Disc (DVD). The semi-conductor memory includes an IC card, an optical card, a mask ROM and an Erasable Programmable ROM (EPROM).

Further, the CPU 201 may load a program stored in the HDD 204 into the RAM 203 for execution in the CPU 201. The program stored in the HDD 204 includes a program downloaded by the CPU 201 from a computer connected to the Internet, or a program written in the HDD 204 by a computer connected to the Internet. The program referred to here includes not only a program directly executable by the CPU 201 but also a source program, a compressed program, an encrypted program or the like.

The respective hardware configurations of the respective MFPs 100, 100-1 to 100-N may be the same or different from one another. Here, the hardware configuration of the MFP 100 having the basic hardware configuration of an image forming apparatus will be described, by way of example.

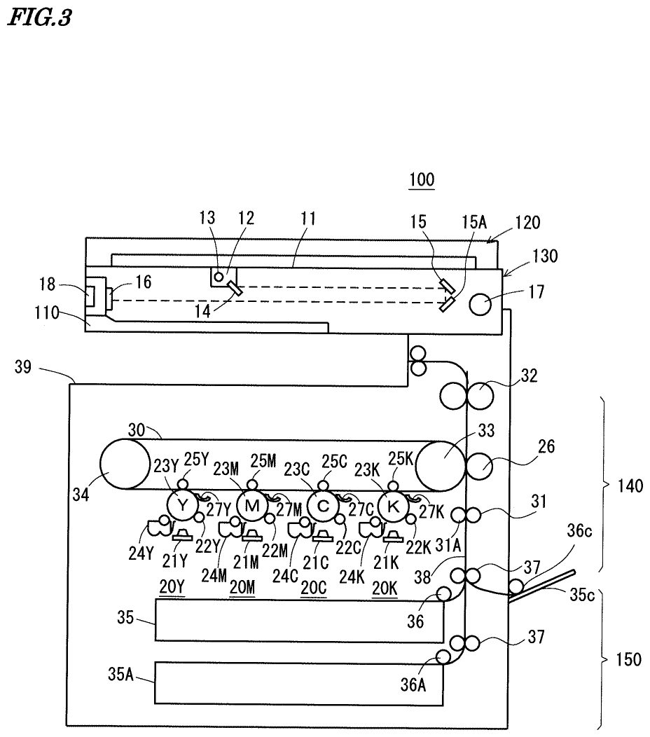

FIG. 3 is a cross-sectional view schematically illustrating one example of the inner configuration of the MFP. With reference to FIG. 3, the MFP 100 includes an automatic document conveyance apparatus 120, a document reading section 130 that reads a document, an image forming section 140 that forms an image on a sheet based on image data and a sheet feed section 150 that feeds a sheet to the image forming section 140.

The automatic document conveyance apparatus 120 automatically conveys a plurality of documents set on a document tray to a predetermined document reading position set on a platen glass of the document reading section 130 one by one. The automatic document conveyance apparatus 120 discharges a document having an image formed thereon by the document reading section 130 onto a document ejection tray.

The document reading section 130 exposes an image of a document set on a document glass 11 with an exposure lamp 13 attached to a slider 12 moving below the document glass 11. The light reflected from the document is guided to a lens 16 by a mirror 14 and two reflecting mirrors 15, 15A, and forms an image on a Charge Coupled Device (CCD) sensor 18.

The reflected light that has formed an image on the CCD sensor 18 is converted into image data as an electric signal in the CCD sensor 18. The image data is converted into print data pieces of cyan (C), magenta (M), yellow (Y) and black (K), and output to the image forming section 140.

The image forming section 140 includes respective image forming units 20Y, 20M, 20C, 20K for respective yellow, magenta, cyan and black.

Here, “Y,” “M,” “C” and “K” represent yellow, magenta, cyan and black, respectively. An image is formed by driving of at least one of the image forming units 20Y, 20M, 20C, 20K. When all of the image forming units 20Y, 20M, 20C, 20K are driven, a full-color image is formed. The print data pieces for yellow, magenta, cyan and black are respectively input to the image forming units 20Y, 20M, 20C, 20K. The only difference among the image forming units 20Y, 20M, 20C, 20K is the colors of toners used by the image forming units 20Y, 20M, 20C, 20K. Therefore, the image forming unit 20Y for forming an image in yellow will be described here.

The image forming unit 20Y includes an exposure device 21Y, a photosensitive drum 23Y, a charging roller 22Y, a developing device 24Y and a primary transfer roller 25Y. Around the photosensitive drum 23Y, the charging roller 22Y, the exposure device 21Y, the developing device 24Y, the primary transfer roller 25Y and a drum cleaning blade 27Y are arranged in this order in a rotation direction of the photosensitive drum 23Y. The yellow print data piece is input to the exposure device 21Y. The photosensitive drum 23Y is an image bearing member. The charging roller 22Y uniformly charges the surface of the photosensitive drum 23Y. The primary transfer roller 25Y transfers a toner image formed on the photosensitive drum 23Y onto an intermediate transfer belt 30, serving as an image bearing member, by the effect of an electric field force.

After being electrically charged by the charging roller 22Y, the photosensitive drum 23Y is irradiated with laser light emitted by the exposure device 21Y. The exposure device 21Y exposes a portion corresponding to the image on the surface of the photosensitive drum 23Y. Thus, an electrostatic latent image is formed on the photosensitive drum 23Y. Subsequently, the developing device 24Y develops the electrostatic latent image formed on the photosensitive drum 23Y with the charged toner. Specifically, toner is placed on the electrostatic latent image formed on the photosensitive drum 23Y by the effect of an electric field force, so that the toner image is formed on the photosensitive drum 23Y. The toner image formed on the photosensitive drum 23Y is transferred onto the intermediate transfer belt 30 serving as an image bearing member by the primary transfer roller 25Y with use of the effect of an electric field force. The toner remaining on the photosensitive drum 23Y without being transferred is removed from the photosensitive drum 23Y by the drum cleaning blade 27Y.

The intermediate transfer belt 30 is suspended by a driving roller 33 and a driven roller 34 so as not to loosen. When the driving roller 33 is rotated in the counterclockwise direction in FIG. 2, the intermediate transfer belt 30 is rotated in the counterclockwise direction in the diagram at a predetermined speed. The driven roller 34 is rotated in the counterclockwise direction in accordance with rotation of the intermediate transfer belt 30.

Thus, the image forming units 20Y, 20M, 20C, 20K sequentially transfer toner images onto the intermediate transfer belt 30. Timing for transferring toner images onto the intermediate transfer belt 30 by the respective image forming units 20Y, 20M, 20C, 20K is adjusted based on detection of a reference mark provided on the intermediate transfer belt 30. Thus, toner images in yellow, magenta, cyan and black are superimposed on the intermediate transfer belt 30.

In the sheet feed cassettes 35, 35A, sheets in different sizes are respectively set. The sheets respectively stored in the sheet feed cassettes 35, 35A are fed to a conveyance path 38 by pickup rollers 36, 36A respectively attached to the sheet feed cassettes 35, 35A and are sent to the timing roller 31 by a sheet feed roller 37.

The sheet conveyed by the timing roller 31 is conveyed to a nip portion in which the intermediate transfer belt 30 and a secondary transfer belt 26 come into contact with each other. A toner image formed on the intermediate transfer belt 30 is transferred onto a sheet with the effect of an electric field force by the secondary transfer belt 26 serving as a transfer member. The sheet to which the toner image has been transferred is conveyed to a fixing roller 32 to be heated and pressurized by the fixing roller 32. Thus, the toner is fused and fixed to the sheet. Thereafter, the sheet is conveyed to the sheet ejection tray 39.

While driving all of the image forming units 20Y, 20M, 20C, 20K in a case in which forming a full-color image, the MFP 100 drives any one of the image forming units 20Y, 20M, 20C, 20K in a case in which forming a monochrome image. It is also possible to form an image by combining two or more of the image forming units 20Y, 20M, 20C, 20K. Here, the MFP 100 uses a tandem-system including the image forming units 20Y, 20M, 20C, 20K that respectively form toner images in four colors on a sheet, by way of example. However, the MFP 100 may use a four-cycle system that sequentially transfers the toner images in four colors onto a sheet using one photosensitive drum.

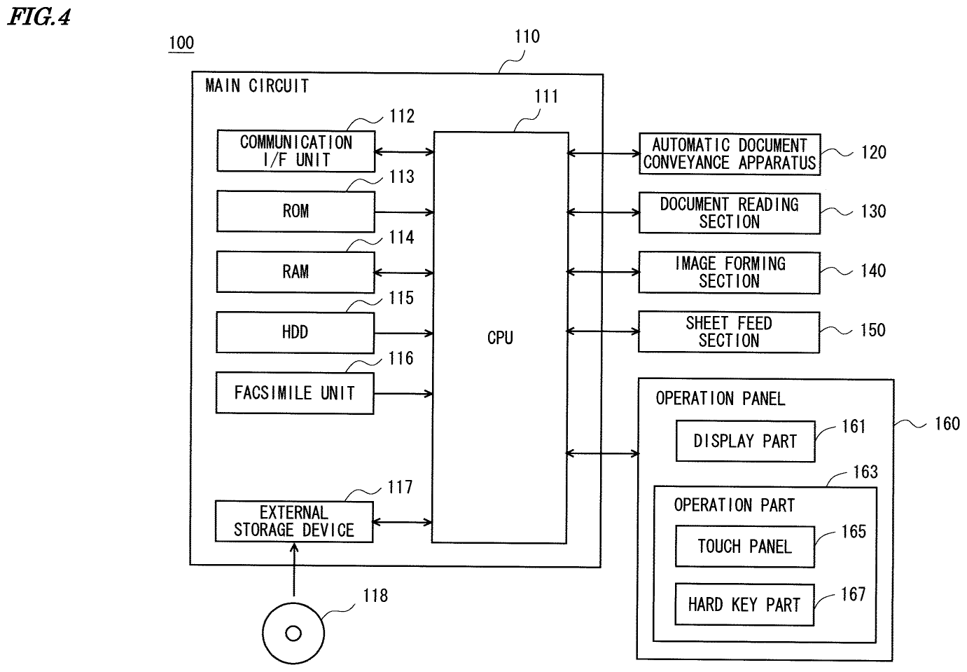

FIG. 4 is a block diagram illustrating the outline of the hardware configuration of the MFP in the present embodiment. With reference to FIG. 4, the MFP 100 includes a main circuit 110, the document reading section 130, the automatic document conveyance apparatus 120, the image forming section 140, the sheet feed section 150, and an operation panel 160. The operation panel 160 is a user interface.

The main circuit 110 includes a CPU 111, a communication interface (I/F) unit 112, a ROM 113, a RAM 114, an HDD 115, a facsimile unit 116 and an external storage device 117. The HDD 115 is a mass storage device. Instead of the HDD 115, a solid state drive (SSD) may be used. The CPU 111 is connected to the automatic document conveyance apparatus 120, the document reading section 130, the image forming section 140, the sheet feed section 150 and the operation panel 160, and controls the MFP 100 as a whole.

The facsimile unit 116 is connected to the Public Switched Telephone Network (PSTN), and transmits facsimile data to the PSTN or receives facsimile data from the PSTN. The facsimile unit 116 stores the received facsimile data in the HDD 115, converts the facsimile data into print data that is printable in the image forming section 140 and outputs the print data to the image forming section 140. Thus, the image forming section 140 forms an image represented by the facsimile data received from the facsimile unit 116 on a sheet. Further, the facsimile unit 116 converts the data stored in the HDD 115 into facsimile data and transmits the converted facsimile data to a facsimile machine connected to the PSTN.

The communication I/F unit 112 is an interface for connecting the MFP 100 to the network 3. The communication I/F unit 112 communicates with the PC 300 connected to the network 3 using a communication protocol such as a Transmission Control Protocol (TCP) or a File Transfer Protocol (FTP).

The ROM 113 stores a program to be executed by the CPU 111 or data required for execution of the program. The RAM 114 is used as a work area when the CPU 111 executes the program. Further, the RAM 114 temporarily stores read images successively sent from the document reading section 130.

The operation panel 160 is provided on an upper surface of the MFP 100. The operation panel 160 includes a display part 161 and an operation part 163. The display part 161 is a Liquid Crystal Display (LCD) device, for example, and displays an instruction menu for a user, information about acquired image data, etc. As long as displaying images, an organic EL display may be used instead of an LCD, for example.

The operation part 163 includes a touch screen 165 and a hard key part 167. The touch screen 165 is a capacitance type. The touch screen 165 is not limited to the capacitance type, and another type such as a resistive film type, a surface acoustic wave type, an infrared type and an electromagnetic induction type can be used. The hard key part 167 includes a plurality of hard keys. The hard keys are contact switches, for example.

The CPU 111 executes a print job received by the communication I/F unit 112 from the PC 300. The print job includes data subject to printing and a printing condition. Data subject to printing may be data in a bitmap format or application data. Data subject to printing includes data for each of one or more pages. The CPU 111 generates image data based on the data that is included in a print job and is subject to printing in accordance with a printing condition included in the print job, and outputs the image data to the image forming section 140.

The external storage device 117 is controlled by the CPU 111 and is mounted with the CD-ROM 118. In the present embodiment, the CPU 201 executes a program stored in the ROM 113, by way of example. The CPU 101 may control the external storage device 117 to read a program to be executed by the CPU 111 from the CD-ROM 118 and store the read program in the RAM 102 for execution.

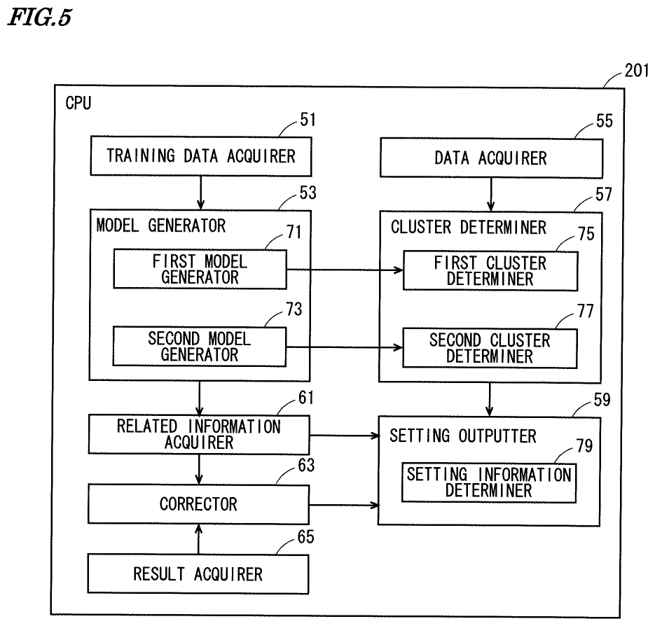

FIG. 5 is a block diagram illustrating one example of the functions of the CPU included in the server in the present embodiment. The functions illustrated in FIG. 5 may be implemented in hardware. Further, they may be implemented by the CPU 201 included in the server 200 by execution of a print setting assistance program stored in the ROM 202, the HDD 204 or the CD-ROM 209A by the CPU 201.

Here, the functions of the CPU 201 in a case in which the user operates the PC 300 and causes the MFP 100 to execute a print job will be described. In this case, the user inputs, to the PC 300, device identification information for identifying a device that is to form an image, data subject to printing and setting information. Here, the device identification information is a device ID of the MFP 100. The setting information includes printing conditions such as information representing a color image or a monochrome image, a sheet type, and image quality. The PC 300 generates a print job based on the data subject to printing and the setting information, and transmits the print job and the device ID of the MFP 100 to the server 200.

With reference to FIG. 5, the CPU 201 included in the server 200 includes a training data acquirer 51, a model generator 53, a data acquirer 55, a cluster determiner 57, a setting outputter 59, a related information acquirer 61, a corrector 63 and a result acquirer 65.

The data acquirer 55 controls the communication part 205 to acquire input data from the PC 300. The input data includes the print job and the device ID of the MFP 100. The data acquirer 55 acquires state information from the MFP 100 and generates job information based on the print job. The state information represents the characteristic of a device use state. The job information represents the characteristic of the print job.

The PC 300 may generate the job information based on the print job. In this case, the data acquirer 55 receives the job information from the PC 300 instead of receiving the print job from the PC 300. Further, the PC 300 may acquire the state information from the MFP 100. In this case, the data acquirer 55 acquires the state information of the MFP 100 from the PC 300.

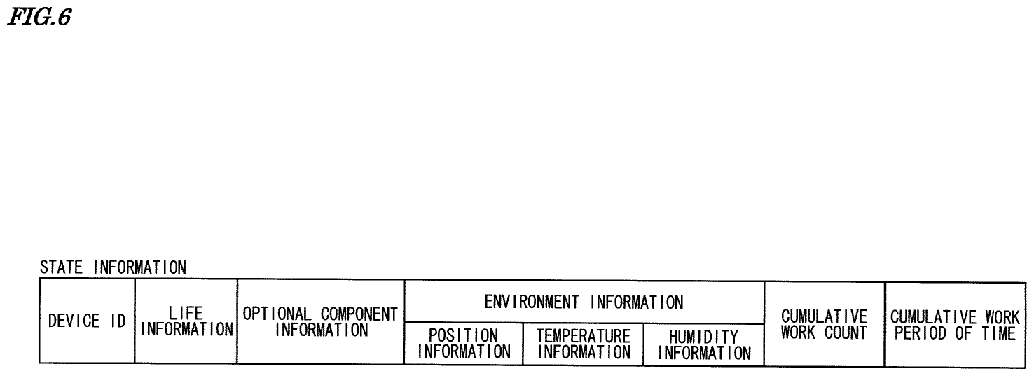

FIG. 6 is a diagram illustrating one example of the format of the state information. With reference to FIG. 6, the state information includes the field for a device ID, the field for life information, the field for optional component information, the field for environment information, the field for a cumulative work count and the field for a cumulative work period of time. In the field for a device ID, the device ID for identifying any one of the MFPs 100, 100-1 to 100-N is set. In the field for life information, the life information representing the product lifespan of a constituent element is set. In the field for optional component information, the optional component information representing whether an optional component is attached is set. In the field for environment information, the environment information representing the state of an environment in which the device is installed is set. The environment information includes at least position information representing a position where the device is installed, temperature information representing a temperature of an environment where the device is set, and humidity information representing a humidity of the environment where the device is installed. In the field for a cumulative work count, the cumulative number of recording media on which images are formed by the device is set. In the field for a cumulative work period of time, the cumulative period of time during which the device has worked is set. The cumulative period of time is a period of time during which the device is powered on. When the device is powered on, in a case in which a work mode is switched between a normal mode and a power saving mode in which power consumption is lower than that in the normal mode, the cumulative period of time may be a cumulative value of a period of time during which the device is in the normal mode.

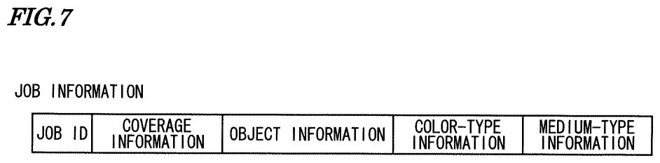

FIG. 7 is a diagram illustrating one example of the format of job information. With reference to FIG. 7, the job information includes the item for a job ID, the item for coverage information, the item for object information, the item for color-type information and the item for medium-type information. In the item for a job ID, the job ID for identifying a print job is set. In the item for coverage information, the coverage information representing the ratio of an image to the area of a recording medium is set. In a case in which image data included in a print job includes a plurality of pages, the coverage information represents the average of the coverage information for each of the plurality of pages. In the item for object information, the object information representing the type of an object included in an image is set. The object includes graphics such as a character, a photograph or a graph. In the item for color-type information, the color-type information representing whether an image to be formed is a color image or a monochrome image is set. In the item for medium-type information, the medium-type information representing the type of a recording medium on which an image is to be formed is set. The medium type may include the size of a recording medium.
(1) While including the life information, the optional component information, the environment information, the cumulative work count and the cumulative work period of time by way of example in the above-mentioned embodiment, the device information is not limited to this. The device information is only required to include at least one of the life information, the optional component information, the environment information, the cumulative work count and the cumulative work period of time. Further, the device information may include another information as long as the information represents the characteristic of a device use state.

While including the coverage information, the object information, the color-type information and the medium-type information by way of example, the job information is not limited to this. The job information is only required to include at least one of the coverage information, the object information, the color-type information and the medium-type information. Further, the job information may include another information as long as the information represents the characteristic of a print job.

With reference back to FIG. 5, the state information acquired by the data acquirer 55 is referred to as first state information, and the job information generated by the data acquirer 55 is referred to as first job information. The first state information represents the characteristic of a use state of the MFP 100 in which a print job is to be executed by the user. The first job information represents the characteristic of a print job, which the user is to cause the MFP 100 to execute. The data acquirer 55 outputs the first state information and the first job information to the cluster determiner 57.

The training data acquirer 51 controls the communication part 205 to acquire training data from each of the MFPs 100-1 to 100-N. The training data includes state the information and the job information. The state information included in the training data is referred to as second state information, and the job information included in the training data is referred to as second job information.

There is one second state information piece for one device. The number of second job information pieces is the same as the number of print jobs that have been executed by the device. For example, the second state information acquired from the MFP 100-1 is the state information acquired at one point in time at which the MFP 100-1 works in one day. Further, the second job information acquired from the MFP 100-1 is one or more job information pieces respectively corresponding to one or more print jobs that have been executed by the MFP 100-1 on the same day as the first state information is acquired from the MFP 100-1. Therefore, the training data acquirer 51 acquires one second state information piece and one or more second job information pieces for each day from the MFP 100-1. Instead of acquiring second job information from the MFP 100-1, the training data acquirer 51 may acquire a print job from MFP 100-1 and generate second job information based on the print job. The training data acquirer 51 outputs the training data to the model generator 53.

The model generator 53 generates a learning model that has executed machine learning using the training data. The model generator 53 includes a first model generator 71 and a second model generator 73.

The first model generator 71 generates a first learning model by executing machine learning using the second state information of the training data. The first model generator 71 causes the first learning model to execute unsupervised learning using the second state information of the training data. The second state information of the training data includes the second state information acquired from each of MFPs 100-1 to 100-N. In the present embodiment, the first model generator 71 converts values of a plurality of fields included in the second state information into a first summary statistic that is digitized in accordance with a predetermined rule, and causes the first learning model to learn the first summary statistic. The first learning model is a classifying model that classifies the second state information into clusters of a first cluster number n1. The first model generator 71 uses k-means clustering as a cluster classification method in the training for the first learning model. The cluster classification method is not limited to this, hierarchical clustering or density-based spatial clustering of applications with noise (DBSCAN) may be used, for example.

Further, the first cluster number n1 is obtained using the elbow method. In the present embodiment, the first cluster number n1 is 2, by way of example. The first cluster number n1 is not limited to this, and may be a value larger than 2. When receiving the first summary statistic of the state information, the first learning model generated by the first model generator 71 outputs a value indicating which of the two clusters the state information belongs to. The first model generator 71 outputs the trained first learning model to the cluster determiner 57.

The first model generator 71 outputs first generation information to the related information acquirer 61. The first generation information includes a plurality of second state information pieces used for training the first learning model, and cluster identification information for identifying one or more clusters into which the second state information pieces are classified by the first learning model.

The second model generator 73 generates a second learning model by executing machine learning using the second job information of the training data. The second model generator 73 causes the second learning model to execute unsupervised learning using the second job information of the training data. The second job information of the training data includes one or more job information pieces respectively acquired from the MFPs 100-1 to 100-N. In the present embodiment, the second model generator 73 converts values of a plurality of fields included in the second job information into a second summary statistic that is digitized in accordance with a predetermined rule, and causes the second learning model to learn the second summary statistic. The second learning model is a classification model for classifying the second job information into one or more clusters of a second cluster number n2. The second model generator 73 uses the k-means method as the cluster classification method in the training for the second learning model. Further, the second cluster number n2 is obtained using the elbow method. In the present embodiment, the second cluster number n2 is 4, by way of example. The second cluster number n2 is not limited to this, and may be a value larger than 4. When receiving the second summary statistic of the job information pieces, the second learning model generated by the second model generator 73 outputs a value indicating which one of the four clusters the job information belongs to. The second model generator 73 outputs the trained second learning model to the cluster determiner 57.

The second model generator 73 outputs second generation information to the related information acquirer 61. The second generation information includes a plurality of second job information pieces used for training the second learning model, and cluster identification information for identifying clusters into which the second job information pieces are classified by the second learning model.

The cluster determiner 57 receives the first state information and the first job information from the data acquirer 55. The cluster determiner 57 receives the first learning model and the second learning model from the model generator 53. The cluster determiner 57 includes a first cluster determiner 75 and a second cluster determiner 77.

The first cluster determiner 75 determines a first job cluster for the first state information by using the first learning model. The first cluster determiner 75 provides a first summary statistic obtained when the first state information is converted in accordance with a predetermined rule to the first learning model, and determines a first cluster output by the first learning model as the first job cluster. The first cluster determiner 75 outputs the first job cluster to the setting outputter 59.

The second cluster determiner 77 determines a second job cluster for the first job information by using the second learning model. The second cluster determiner 77 provides a second summary statistic obtained when the first job information is converted in accordance with a predetermined rule to the second learning model, and determines a second cluster output by the second learning model as the second job cluster. The second cluster determiner 77 outputs the second job cluster to the setting outputer 59.

The related information acquirer 61 acquires related information. The related information associates a set having one of a plurality of first clusters and one of a plurality of second clusters with setting information. The related information is predetermined information and is stored in the HDD 204. The related information is generated based on the first generation information and the second generation information. The related information is generated by a developer of the MFP 100, for example. The developer determines the setting information for each of eight sets made of two first clusters of the first generation information and four second clusters of the second generation information. The setting information determined by the developer is associated with each of the eight sets. The related information acquirer 61 outputs the related information to the corrector 63 and the setting outputter 59.

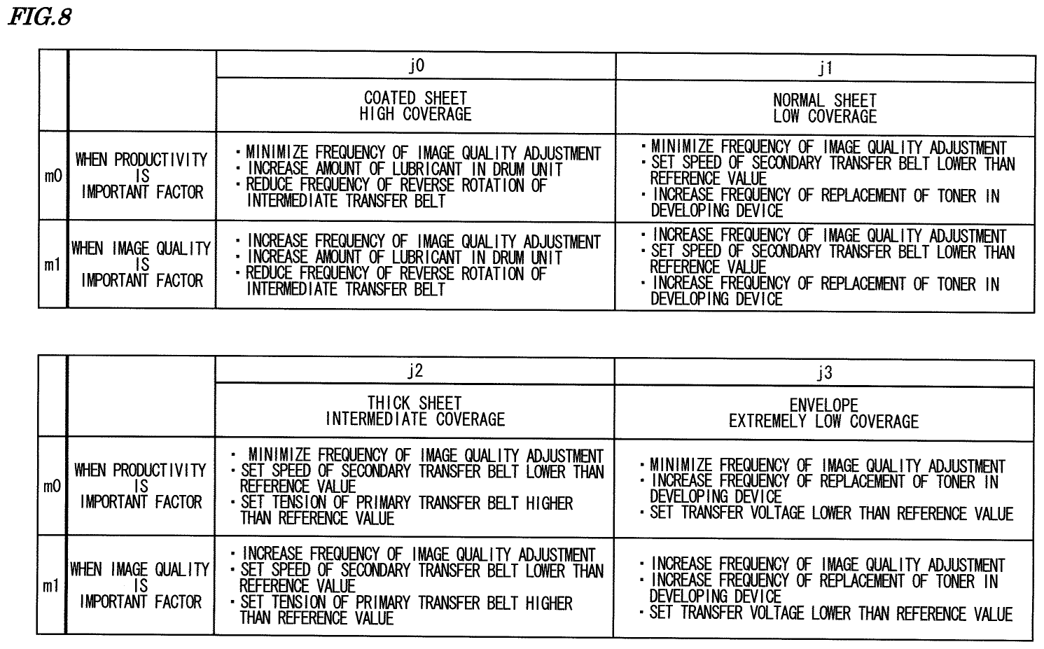

FIG. 8 is a diagram illustrating one example of the related information. With reference to FIG. 8, the related information defines setting information pieces corresponding to eight sets made of two first clusters m0, m1 and four second clusters j0, j1, j2, j3. For example, three setting information pieces are associated with the set having the first cluster of m0 and the second cluster of j0. The three setting information pieces define a condition for minimizing the frequency of image quality adjustment, a condition for increasing an amount of lubricant in the photosensitive drums 23Y, 23M, 23C, 23K included in the image forming section 140, and a condition for reducing the frequency of reverse rotation of the intermediate transfer belt 30 included in the image forming section 140. The setting information pieces illustrated in FIG. 8 are represented by characters as preferable setting methods in order to facilitate understanding of the user. In a setting information piece included in the related information, a setting value indicating a numerical value may be defined for a setting item.

With reference back to FIG. 5, the setting outputter 59 receives the first job cluster corresponding to the first state information and the second job cluster corresponding to the first job information from the cluster determiner 57. The setting information determiner 79 receives the related information from the related information acquirer 61. The setting outputter 59 includes the setting information determiner 79. The setting information determiner 79 determines setting information pieces associated with the first job cluster and the second job cluster with reference to the related information.

The setting outputter 59 outputs the setting information pieces. For example, the setting outputter 59 controls the communication part 205 to transmit the setting information pieces to the MFP 100 and causes the MFP 100 to set printing conditions based on the setting information pieces. Further, the MFP 100 may control the communication part 205 to transmit a print job to the MFP 100 and cause the MFP 100 to execute the print job. Further, the setting outputter 59 may control the communication part 205 to transmit the setting information pieces to the PC 300 and cause the PC 300 to display the setting information pieces.

The result acquirer 65 acquires result setting information from a device, i.e., the MFP 100 in which the setting information pieces output by the setting outputter 59 are to be set. The result setting information is the setting information pieces that are actually set when the MFP 100 executes the print job. The result acquirer 65 outputs the result setting information to the corrector 63.

The corrector 63 receives the related information from the related information acquirer 61, and acquires the result setting information from the result acquirer 65. The corrector 63 corrects the related information with the result setting information. The corrector 63 outputs the corrected related information to the setting outputter 59. After receiving the corrected related information from the corrector 63, the setting outputter 59 determines setting information pieces using the corrected related information received from the corrector 63 instead of the related information received from the related information acquirer 61.

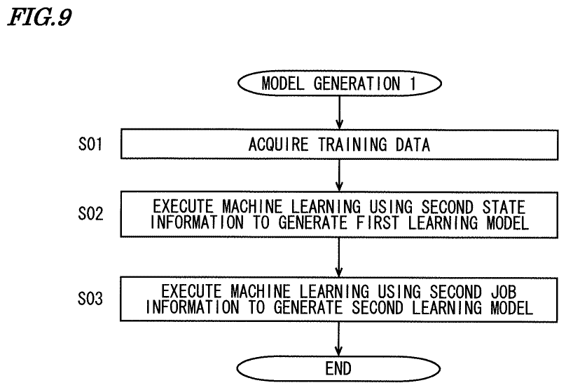

FIG. 9 is a flowchart illustrating one example of a flow of a model generation process. The model generation process is executed by the CPU 201 included in the server 200 when the CPU 201 executes a model generation program stored in the ROM 202, the HDD 204 and the CD-ROM 209A. The model generation program is part of the print setting assistance program.

With reference to FIG. 9, the CPU 201 included in the server 200 acquires training data (step S01), and the process proceeds to the step S02. The CPU 201 controls the communication part 205 to acquire training data from each of the MFPs 100-1 to 100-N. The training data includes second state information and second job information. The CPU 201 acquires, as the training data, one second state information piece for each day from each of the MFPs 100-1 to 100-N, and one or more second job information pieces. The CPU 201 may acquire training data for a plurality of days from each of the MFPs 100-1 to 100-N. Further, the CPU 201 may acquire training data for each day from each of the MFPs 100-1 to 100-N and store them in the HDD 204. The CPU 201 may read training data for a plurality of days stored in the HDD 204.

In the step S02, the CPU 201 executes machine learning using the second state information to generate a first learning model, and the process proceeds to the step S03. Specifically, the CPU 201 causes the first learning model to execute unsupervised learning using the second state information. The CPU 201 converts values of a plurality of fields included in the second state information into a first summary statistic that is digitized in accordance with a predetermined rule, and causes the first learning model to learn the first summary statistic. The first learning model is a classifying model that classifies the second state information into clusters of a first cluster number n1. The first cluster number n1 is 2 and is obtained using the elbow method.

In the step S03, the CPU 201 executes machine learning using the second job information to generate a second learning model, and the process ends. Specifically, the CPU 201 causes the second learning model to execute unsupervised learning using the second job information. The CPU 201 converts values of a plurality of fields included in the second job information into a second summary statistic which is digitized in accordance with a predetermined rule, and causes the second learning model to learn the second summary statistic. The second learning model is a classification model for classifying the second job information into one or more clusters of a second cluster number n2. The second cluster number n2 is 4 and is obtained using the elbow method.

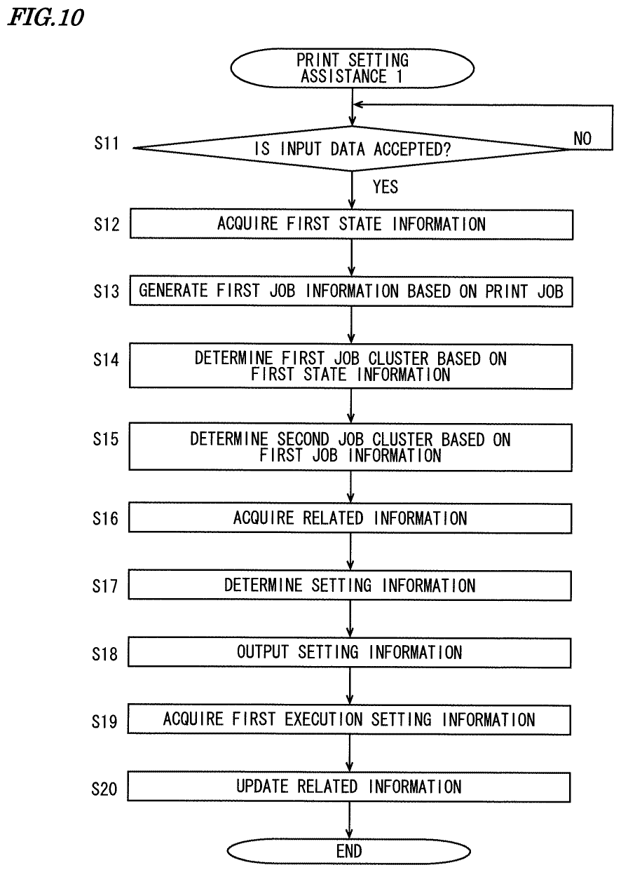

FIG. 10 is a flowchart illustrating one example of a flow of a print setting assistance process. The print setting assistance process is a process executed by the CPU 201 included in the server 200 when the CPU 201 executes the print setting assistance program stored in the ROM 202, the HDD 204 and the CD-ROM 209A. With reference to FIG. 10, the CPU 201 included in the server 200 determines whether input data has been accepted (step S11). The CPU 201 waits until the communication part 205 receives the input data from the PC 300 (NO in the step S11). When the CPU 201 receives the input data (YES in the step S11), the process proceeds to the step S12. Here, the input data includes a print job and the device ID of the MFP 100, by way of example.

In the step S12, first state information is acquired, and the process proceeds to the step S13. The CPU 201 specifies the MFP 100 based on the device ID included in the input data and acquires the first state information from the MFP 100. In the step S13, job information is generated based on the print job included in the input data, and the process proceeds to the step S14.

In the next step S14, a first job cluster is determined based on the first state information, and the process proceeds to the step S15. The CPU 201 converts values of a plurality of fields included in the first state information acquired in the step S12 into a first summary statistic that is digitized in accordance with a predetermined rule. Next, the CPU 201 provides the first summary statistic to the first learning model, and acquires a first cluster output by the first learning model as the first job cluster.

In the step S15, a second job cluster is determined based on the first job information, and the process proceeds to the step S16. The CPU 201 converts values of a plurality of fields included in the first job information generated in the step S13 into a second summary statistic which is a numerical value digitized in accordance with a predetermined rule. Next, the CPU 201 provides the second summary statistic to a second learning model, and acquires a second cluster output by the second learning model as the second job cluster.

In the step S16, related information is acquired, and the process proceeds to the step S17. The CPU 201 reads the related information stored in the HDD 204. In the step S17, the CPU 201 determines setting information, and the process proceeds to the step S18. The CPU 201 determines the setting information associated with a set of the first job cluster and the second job cluster by the related information.

In the step S18, the setting information is output, and the process proceeds to the step S19. The CPU 201 controls the communication part 205 to transmit the setting information to the PC 300 that has transmitted the input data. The user who operates the PC 300 can change the setting contents or the like by referring to the setting information displayed on the PC 300.

In the step S19, first execution setting information is acquired, and the process proceeds to the step S20. The first execution setting information is the setting information that is set in the MFP 100 when a print job is executed by the MFP 100. The CPU 201 acquires the first execution setting information from the MFP 100. The CPU 201 may acquire the first execution setting information from the PC 300 that generates the print job.

In the step S20, the related information is updated, and the process ends. The related information stored in the HDD 204 is updated with the first execution setting information acquired in the step S19. The updated related information may be stored in the HDD 204 as the related information corresponding to the MFP 100 specified by a device ID included in the input data accepted in the step S11. In this case, the related information corresponding to each of the MFPs 100, 100-1 to 100-N is stored in the HDD 204.

### Modified Examples

In the service providing system 1 in the above-mentioned embodiment, the server 200 stores related information in the HDD 204, and determines setting information using the related information. In a service providing system 1 in a modified example, a server 200 determines setting information without using related information.

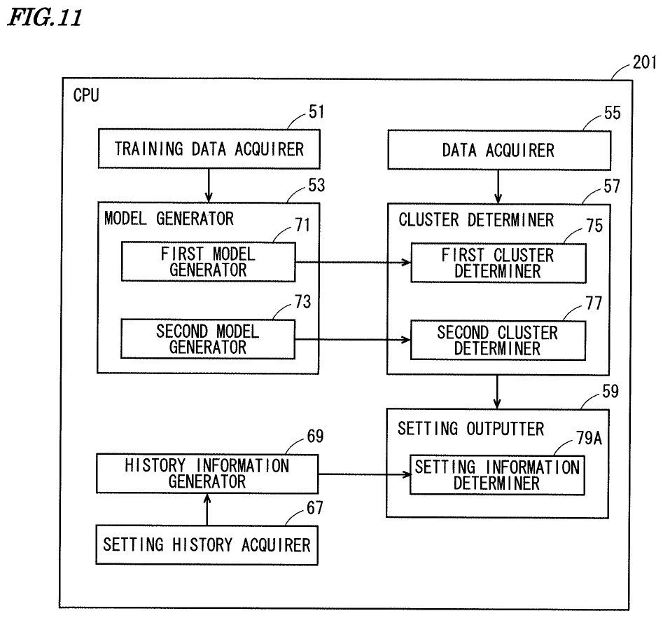

FIG. 11 is a block diagram illustrating one example of the functions of a CPU included in the server 200 in the modified example. With reference to FIG. 11, the functions are different from those illustrated in FIG. 5 in that the related information acquirer 61, the corrector 63 and the result acquirer 65 are removed, the setting information determiner 79 is changed to a setting information determiner 79A, and a setting history acquirer 67 and a history information generator 69 are added. The other functions are the same as the functions illustrated in FIG. 5. Therefore, a description thereof will not be repeated.

The setting history acquirer 67 acquires setting history information. The setting history acquirer 67 controls a communication part 205 to acquire the setting history information from each of MFPs 100, 100-1 to 100-N. The setting history information is the setting information that is set when an executed print job, which is a print job that has been executed in each of the MFPs 100, 100-1 to 100-N, is executed. The setting history acquirer 67 outputs the setting history information to the history information generator 69.

The history information generator 69 generates history information that associates a first job cluster and a second job cluster determined by a cluster determiner 57 in regard to the executed print job with the setting history information. The history information generator 69 outputs the history information to the setting information determiner 79A.

The setting information determiner 79A receives the first job cluster corresponding to first state information and the second job cluster corresponding to first job information from the cluster determiner 57. The setting information determiner 79A receives history information from the history information generator 69. The setting information determiner 79A refers to the history information and determines the setting history information associated with the first job cluster and the second job cluster as setting information.

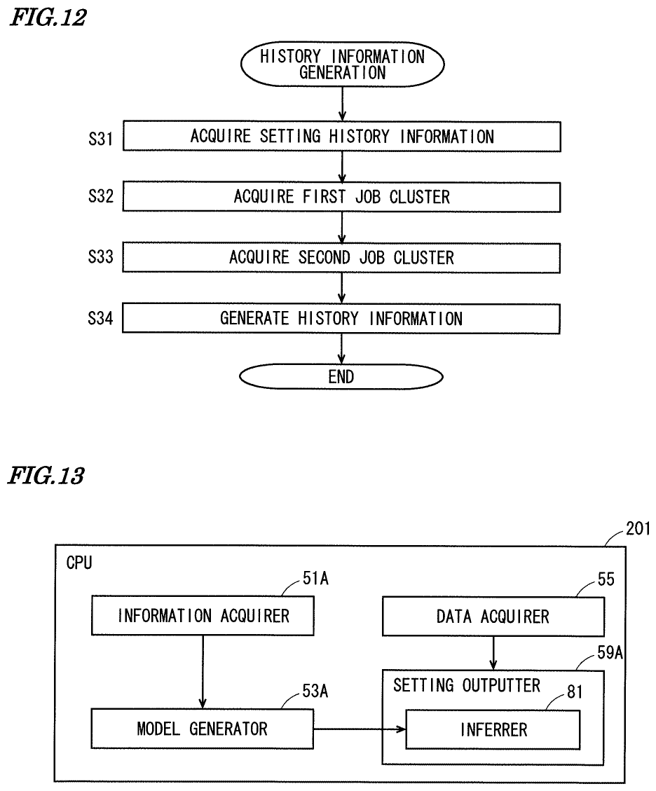

FIG. 12 is a flowchart illustrating one example of a flow of a history information generation process. The history information generation process is executed by a CPU 201 included in the server 200 when the CPU 201 executes a history information generation program stored in a ROM 202, an HDD 204 and a CD-ROM 209A. The history information generation program is part of a print setting assistance program.

With reference to FIG. 12, the CPU 201 included in server 200 acquires setting history information (step S31), and the process proceeds to the step S32. The CPU 201 controls a communication part 205 to acquire setting history information from each of MFPs 100, 100-1 to 100-N. The setting history information is the setting information that is set for an executed print job that has been executed in the device.

In the step S32, the CPU 201 acquires a first job cluster, and the process proceeds to the step S33. The first job cluster is determined in the step S14 when the print setting assistance process is executed for an executed print job.

In the step S33, a CPU 201 acquires a second job cluster, and the process proceeds to the step S34. The second job cluster is determined in the step S15 when the print setting assistance process is executed for an executed print job.

In the step S34, the CPU 201 generates history information, and the process ends. The history information that associates the setting history information acquired in the step S31, the first job cluster acquired in the step S32, and the second job cluster acquired in the step S33 with one another is generated. One history information piece is generated for each executed print job. In a case in which there are a plurality of setting history information pieces for a set of a first job cluster and a second job cluster, history information that associates the average of the plurality of setting history information pieces with the set of the first job cluster and the second job cluster is generated. History information may be generated for each of the plurality of MFPs 100, 100-1 to 100-N, or history information common to the plurality of MFPs 100, 100-1 to 100-N may be generated.

### Second Embodiment

In the service providing system 1 in the first embodiment, the server 200 determines setting information using a first learning model and a second learning model. In a service providing system 1 in a second embodiment, a server 200 determines setting information using a single third learning model.

The hardware configuration of a service providing system 1 in the second embodiment is the same as that of the service providing system 1 in the first embodiment. Therefore, the differences of the service providing system 1 in the second embodiment from the service providing system 1 in the first embodiment will be mainly described below.

FIG. 13 is a block diagram illustrating one example of the functions of a CPU included in the server in the second embodiment. The functions illustrated in FIG. 13 may be realized by hardware. Further, they may be implemented by a CPU 201 included in the server 200 by execution of a print setting assistance program stored in a ROM 202, an HDD 204 or a CD-ROM 209A by the CPU 201. With reference to FIG. 13, the CPU 201 included in the server 200 in the second embodiment includes an information acquirer 51A, a model generator 53A, a data acquirer 55 and a setting outputter 59A.

The information acquirer 51A controls a communication part 205 to acquire job-related information from each of MFPs 100-1 to 100-N. The job-related information includes state information, job information and second execution setting information. The state information included in the job-related information is referred to as second state information, and the job information included in the job-related information is referred to as second job information. The second execution setting information is the setting information that is used when a print job corresponding to the second job information is executed. The information acquirer 51A outputs the job-related information to the model generator 53A.

The model generator 53A generates a third learning model that has executed machine learning using the job related information as training data. The model generator 53A causes the third learning model to execute machine learning using the training data in which the second state information and the second job information of the job-related information are set as explanatory variables and the second execution setting information of the job-related information is set as an objective variable. The model generator 53A outputs a trained third learning model to the setting outputter 59A.

The data acquirer 55 controls the communication part 205 to acquire input data from a PC 300. The input data includes a print job and a device ID of the MFP 100. The data acquirer 55 acquires first state information from the MFP 100 and generates first job information based on the print job. The data acquirer 55 outputs the first state information and the first job information to the setting outputer 59A.

The setting outputter 59A receives the first state information and the first job information from the data acquirer 55, and receives the third learning model from the model generator 53A. The setting outputter 59A includes an inferrer 81. The inferrer 81 infers setting information based on the first state information and the first job information by using the third learning model.

The setting outputter 59A outputs the setting information inferred by the inferrer 81. For example, the setting outputter 59A controls the communication part 205 to transmit the setting information to the MFP 100 and causes the MFP 100 to set a printing condition based on the setting information. Further, the MFP 100 controls the communication part 205 to transmit a print job to the MFP 100 and causes the MFP 100 to execute the print job. Further, the setting outputter 59A may also control the communication part 205 to transmit the setting information to the PC 300, and may cause the PC 300 to display the setting information.

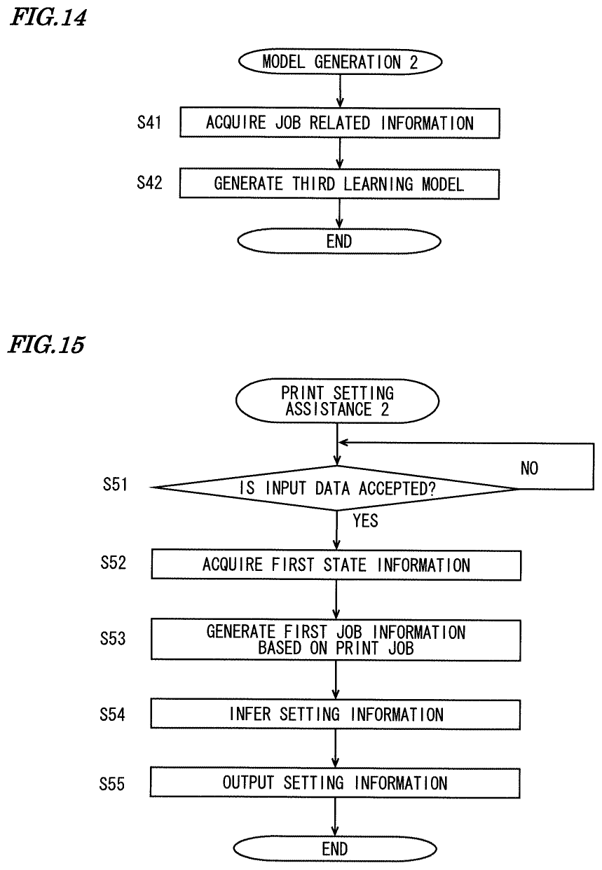

FIG. 14 is a flowchart illustrating one example of a flow of a model generation process in the second embodiment. With reference to FIG. 14, the CPU 201 included in the server 200 acquires job-related information (step S41), and the process proceeds to the step S42. The CPU 201 controls the communication part 205 to acquire the job-related information from each of the MFPs 100-1 to 100-N. The job-related information includes second state information, second job information and second execution setting information.

In the step S42, the third learning model is generated, and the process ends. The CPU 201 causes the third learning model to execute machine learning using the second state information and the second job information of the second training data acquired in the step S41 as explanatory variables and using the second execution setting information of the second training data as an objective variable. The CPU 201 determines a trained third learning model as the third learning model.

FIG. 15 is a flowchart illustrating one example of a flow of a print setting assistance process in the second embodiment. With reference to FIG. 15, the steps S51 to S53 are the same as the steps S11 to S13 of FIG. 10. Therefore, a description thereof will not be repeated here.

In the step S54, setting information is inferred, and the process proceeds to the step S55. The CPU 201 provides first state information and second job information to the third learning model generated by the model generation process, and causes the third learning model to infer the setting information.

In the step S55, the setting information is output, and the process ends. The CPU 201 controls the communication part 205 to transmit the setting information to the PC 300 that has transmitted input data. The user who operates the PC 300 can change the setting contents or the like by referring to the setting information displayed on the PC 300.

### Overview of Embodiment

(Item 1) A service providing system includes a hardware processor, wherein the hardware processor acquires respective state information and job information as respective first state information and first job information, with the state information representing a characteristic of a device use state relating to a first image forming apparatus, and with the job information representing a characteristic of a print job relating to a first print job to be executed by the first image forming apparatus, and outputs setting information for execution of the first print job by using a learning model, with the setting information being determined based on the first state information and the first job information, and with the learning model having executed machine learning using second state information that is the state information of each of a plurality of second image forming apparatuses and second job information that is the job information corresponding to a second print job that has been executed in each of the second plurality of image forming apparatuses.

According to this aspect, the first state information representing the characteristic of the use state of the first image forming apparatus and the first job information relating to the first print job to be executed by the first image forming apparatus are acquired, and the setting information determined based on the first state information and the first job information is output by the learning model. The learning model is a model that has executed machine learning using the second state information and the second job information relating to each of the plurality of second image forming apparatuses. Therefore, because the setting information suitable for the use state of the first image forming apparatus and the print job to be executed is output, it is possible to execute the first print job under the condition suitable for the use state of the first image forming apparatus. As a result, it is possible to provide the service providing system capable of assisting setting work for execution of the print job.
(Item 2) The service providing system according to item 1, wherein the hardware processor acquires the second state information and the second job information from each of the plurality of second image forming apparatuses, and generates the learning model that has executed machine learning using a plurality of the second state information pieces and a plurality of the second job information pieces.

According to this aspect, the second state information and the second job information are acquired from each of the plurality of second image forming apparatuses, and the learning model that has executed machine learning using the second state information and the second job information is generated. Therefore, because the learning model is generated based on the information acquired from the plurality of second image forming apparatuses, it is possible to output the setting information suitable for the use state of the first image forming apparatus.
(Item 3) The service providing system according to item 1 or 2, wherein the learning model includes a first learning model that classifies each of the plurality of the second state information pieces into any one of a plurality of first clusters, and a second learning model that classifies each of the plurality of the second job information pieces into any one of a plurality of second clusters, and the hardware processor determines a first job cluster into which the first state information is classified by the first learning model among the plurality of first clusters, and determines a second job cluster into which the first job information is classified by the second learning model among the plurality of second clusters, acquires related information that associates the setting information with a set of any one of the plurality of first clusters and any one of the plurality of second clusters, and determines the setting information that is associated with the first job cluster and the second job cluster by the related information.

According to this aspect, the first job cluster is determined using the first learning model based on the first state information, the second job cluster is determined using the second learning model based on the first job information, and the setting information associated with the first job cluster and the second job cluster by the related information is determined. Therefore, it is possible to easily determine the setting information suitable for execution of the first print job by the first image forming apparatus.
(Item 4) The service providing system according to item 3, wherein the hardware processor, in the first image forming apparatus, acquires first execution setting information that is the setting information set when the first print job is executed by the first image forming apparatus, and corrects the related information based on the first execution setting information.

According to this aspect, in the first image forming apparatus, the related information is corrected based on the first execution setting information that is set when the first print job is executed. Therefore, the related information can be customized to correspond to the first image forming apparatus.
(Item 5) The service providing system according to item 1 or 2, wherein the learning model includes a first learning model that classifies each of the plurality of the second state information pieces into any one of a plurality of first clusters, and a second learning model that classifies each of the plurality of the second job information pieces into any one of a plurality of second clusters, and the hardware processor determines a first job cluster into which the first state information is classified by the first learning model among the plurality of first clusters, and determines a second job cluster into which the first job information is classified by the second learning model among the plurality of second clusters, generates history information that associates the first job cluster and the second job cluster that are determined for an executed print job that has been executed in past in the first image forming apparatus with setting history information that is the setting information according to which the executed print job has been executed, and determines, as the setting information, the setting history information that is associated by the history information with the first job cluster determined for the first state information and the second job cluster determined for the first job information.

According to this aspect, in the first image forming apparatus, the history information that associates the first job cluster and the second job cluster determined for the executed print job that has been executed in the past with the setting history information of the executed print job is generated, and the setting history information associated with the first job cluster determined for the first state information and the second job cluster determined for the first job information by the history information is determined as the setting information. Therefore, it is possible to output the setting information suitable for the state of the first image forming apparatus.
(Item 6) The service providing system according to item 1, wherein the hardware processor acquires the second state information and the second job information from each of the plurality of second image forming apparatuses, acquires, from each of the plurality of second image forming apparatuses, the second state information, the second job information, and second execution setting information that is the setting information according to which a print job corresponding to the second job information has been executed, and generates the learning model that has executed machine learning using training data in which the second state information and the second job information are set as explanatory variables and the second execution setting information is set as an objective variable.

According to this aspect, the learning model that has executed machine learning using the training data in which the second state information and the second job information acquired from each of the plurality of second image forming apparatuses are set as explanatory variables and the second execution setting information is set as an objective variable. Therefore, it is possible to cause the learning model to infer the setting information based on the first state information and the first job information.
(Item 7) The service providing system according to any one of items 1 to 6, wherein the hardware processor causes the first image forming apparatus to execute the first print job in accordance with the setting information.

According to this aspect, because the print job is executed in accordance with the setting information in the first image forming apparatus, it is not necessary for the user to set the setting information, and an operation can be simplified.
(Item 8) The service providing system according to any one of items 1 to 7, wherein the hardware processor notifies a user who has set the first job information of the setting information.

According to this aspect, the user who has set the job information is notified of the setting information. Therefore, the user can cause the first image forming apparatus to execute the print job after confirming the setting information.
(Item 9) The service providing system according to any one of items 1 to 8, wherein the state information includes at least one of life information representing a lifespan of a constituent element, optional component information representing whether an optional component is attached, environment information representing a state of an environment in which a device is installed, a cumulative work count representing a cumulative number of recording media on which images are formed, and a cumulative work period of time during which the device has worked.
(Item 10) The service providing system according to any one of items 1 to 9, wherein the job information includes at least one of coverage information representing a ratio of an image to an area of a recording medium, object information representing a type of an object included in an image, color-type information representing whether an image is a color image or a monochrome image, and medium-type information representing a type of a recording medium on which an image is to be formed.
(Item 11) A service providing server includes a data acquirer that acquires respective state information and job information as respective first state information and first job information, with the state information representing a characteristic of a device use state relating to a first image forming apparatus, and with the job information representing a characteristic of a print job relating to a first print job to be executed by the first image forming apparatus, and a setting outputter that outputs setting information for execution of the first print job by using a learning model, with the setting information being determined based on the first state information and the first job information, and with the learning model having executed machine learning using second state information that is the state information of each of a plurality of second image forming apparatuses and second job information that is the job information corresponding to a second print job that has been executed in each of the plurality of second image forming apparatuses.

According to this aspect, it is possible to provide the service providing server capable of assisting the setting work for execution of the print job.
(Item 12) A print setting assistance method causes a service providing server to execute a data acquiring step of acquiring respective state information and job information as respective first state information and first job information, with the state information representing a characteristic of a device use state relating to a first image forming apparatus, and with the job information representing a characteristic of a print job relating to a first print job to be executed by the first image forming apparatus, and a setting output step of outputting setting information for execution of the first print job by using a learning model, with the setting information being determined based on the first state information and the first job information, and with the learning model having executed machine learning using second state information that is the state information of each of a plurality of second image forming apparatuses and second job information that is the job information corresponding to a second print job that has been executed in each of the plurality of second image forming apparatuses.

According to this aspect, it is possible to provide the print setting assistance method with which the setting work for execution of the print job can be assisted.
(Item 13) A non-transitory computer-readable recording medium is encoded with a print setting assistance program that causes a computer to execute a data acquiring step of acquiring respective state information and job information as respective first state information and first job information, with the state information representing a characteristic of a device use state relating to a first image forming apparatus, and with the job information representing a characteristic of a print job relating to a first print job to be executed by the first image forming apparatus, and a setting output step of outputting setting information for execution of the first print job by using a learning model, with the setting information being determined based on the first state information and the first job information, and with the learning model having executed machine learning using second state information that is the state information of each of a plurality of second image forming apparatuses and second job information that is the job information corresponding to a second print job that has been executed in each of the plurality of second image forming apparatuses.

According to this aspect, it is possible to provide the print setting assistance program capable of assisting the setting operation for execution of the print job.

Although embodiments of the present invention have been described and illustrated in detail, the disclosed embodiments are made for purpose of illustration and example only and not limitation. The scope of the present invention should be interpreted by terms of the appended claims.

What is claimed is:

1. A service providing system comprising a hardware processor,
the hardware processor:
acquiring respective state information and job information as respective first state information and first job information, the state information representing a characteristic of a device use state relating to a first image forming apparatus, the job information representing a characteristic of a print job relating to a first print job to be executed by the first image forming apparatus; and
outputting setting information for execution of the first print job by using a learning model, the setting information being determined based on the first state information and the first job information, the learning model having executed machine learning using second state information that is the state information of each of a plurality of second image forming apparatuses and second job information that is the job information corresponding to a second print job that has been executed in each of the plurality of second image forming apparatuses.

2. The service providing system according to claim 1, wherein
the hardware processor
acquires the second state information and the second job information from each of the plurality of second image forming apparatuses, and
generates the learning model that has executed machine learning using a plurality of the second state information pieces and a plurality of the second job information pieces.

3. The service providing system according to claim 1, wherein
the learning model includes
a first learning model that classifies each of the plurality of the second state information pieces into any one of a plurality of first clusters, and
a second learning model that classifies each of the plurality of the second job information pieces into any one of a plurality of second clusters, and
the hardware processor
determines a first job cluster into which the first state information is classified by the first learning model among the plurality of first clusters, and determines a second job cluster into which the first job information is classified by the second learning model among the plurality of second clusters,
acquires related information that associates the setting information with a set of any one of the plurality of first clusters and any one of the plurality of second clusters, and
determines the setting information that is associated with the first job cluster and the second job cluster by the related information.

4. The service providing system according to claim 3, wherein
the hardware processor,
in the first image forming apparatus, acquires first execution setting information that is the setting information set when the first print job is executed by the first image forming apparatus, and
corrects the related information based on the first execution setting information.

5. The service providing system according to claim 1, wherein
the learning model includes
a first learning model that classifies each of the plurality of the second state information pieces into any one of a plurality of first clusters, and
a second learning model that classifies each of the plurality of the second job information pieces into any one of a plurality of second clusters, and
the hardware processor
determines a first job cluster into which the first state information is classified by the first learning model among the plurality of first clusters, and determines a second job cluster into which the first job information is classified by the second learning model among the plurality of second clusters,
generates history information that associates the first job cluster and the second job cluster that are determined for an executed print job that has been executed in past in the first image forming apparatus with setting history information that is the setting information according to which the executed print job has been executed, and
determines, as the setting information, the setting history information that is associated by the history information with the first job cluster determined for the first state information and the second job cluster determined for the first job information.

6. The service providing system according to claim 1, wherein
the hardware processor
acquires the second state information and the second job information from each of the plurality of second image forming apparatuses,
acquires, from each of the plurality of second image forming apparatuses, the second state information, the second job information, and second execution setting information that is the setting information according to which a print job corresponding to the second job information has been executed, and
generates the learning model that has executed machine learning using training data in which the second state information and the second job information are set as explanatory variables and the second execution setting information is set as an objective variable.

7. The service providing system according to claim 1, wherein
the hardware processor
causes the first image forming apparatus to execute the first print job in accordance with the setting information.

8. The service providing system according to claim 1, wherein
the hardware processor
notifies a user who has set the first job information of the setting information.

9. The service providing system according to claim 1, wherein
the state information includes at least one of life information representing a lifespan of a constituent element, optional component information representing whether an optional component is attached, environment information representing a state of an environment in which a device is installed, a cumulative work count representing a cumulative number of recording media on which images are formed, and a cumulative work period of time during which the device has worked.

10. The service providing system according to claim 1, wherein
the job information includes at least one of coverage information representing a ratio of an image to an area of a recording medium, object information representing a type of an object included in an image, color-type information representing whether an image is a color image or a monochrome image, and medium-type information representing a type of a recording medium on which an image is to be formed.

11. A service providing server comprising:
a data acquirer that acquires respective state information and job information as respective first state information and first job information, the state information representing a characteristic of a device use state relating to a first image forming apparatus, the job information representing a characteristic of a print job relating to a first print job to be executed by the first image forming apparatus; and
a setting outputter that outputs setting information for execution of the first print job by using a learning model, the setting information being determined based on the first state information and the first job information, the learning model having executed machine learning using second state information that is the state information of each of a plurality of second image forming apparatuses and second job information that is the job information corresponding to a second print job that has been executed in each of the plurality of second image forming apparatuses.

12. A print setting assistance method causing a service providing server to execute:
a data acquiring step of acquiring respective state information and job information as respective first state information and first job information, the state information representing a characteristic of a device use state relating to a first image forming apparatus, the job information representing a characteristic of a print job relating to a first print job to be executed by the first image forming apparatus; and
a setting output step of outputting setting information for execution of the first print job by using a learning model, the setting information being determined based on the first state information and the first job information, the learning model having executed machine learning using second state information that is the state information of each of a plurality of second image forming apparatuses and second job information that is the job information corresponding to a second print job that has been executed in each of the plurality of second image forming apparatuses.

13. A non-transitory computer-readable recording medium encoded with a print setting assistance program that causes a computer to execute:
a data acquiring step of acquiring respective state information and job information as respective first state information and first job information, the state information representing a characteristic of a device use state relating to a first image forming apparatus, the job information representing a characteristic of a print job relating to a first print job to be executed by the first image forming apparatus; and
a setting output step of outputting setting information for execution of the first print job by using a learning model, the setting information being determined based on the first state information and the first job information, the learning model having executed machine learning using second state information that is the state information of each of a plurality of second image forming apparatuses and second job information that is the job information corresponding to a second print job that has been executed in each of the plurality of second image forming apparatuses.
